(19) United States
(12) Patent Application Publication
(10) Pub. No.: US 2004/0258975 A1
(43) Pub. Date: Dec. 23, 2004

(54) Fuel cell component with lyophilic surface

(76) Inventors: Charles W. Extrand, Minneapolis, MN (US); Loxie Monson, Shakopee, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/837,241

(22) Filed: Apr. 30, 2004

Related U.S. Application Data
(60) Provisional application No. 60/468,213, filed on May 5, 2003.

(51) Int. Cl. H01M 8/02; B05D 5/12; H01B 1/24

(52) U.S. Cl. 429/34; 252/511; 427/115; 204/157.15

(57) ABSTRACT

A fuel cell component with surfaces having improved lyophilicity so that liquid on the component adheres closely to the surface in relatively flat droplets or sheets. The lyophilic surfaces may be formed by cold plasma or ultraviolet light treatment of the component. The lyophilic surfaces may be selectively provided on critical areas of the component, such as for example on flow channel wall surfaces of bipolar plates and membrane electrode assemblies, thereby inhibiting liquid blocking of the flow channels during operation of the fuel cell.

### RELATED APPLICATIONS

This application claims the benefit of U.S. Provisional Application No. 60/468,213, filed on May 5, 2003, hereby incorporated herein in its entirety by reference.

### FIELD OF THE INVENTION

The invention relates to fuel cells and more particularly, it relates to fuel cell components having lyophilic surfaces.

### BACKGROUND OF THE INVENTION

Fuel cell technology has been the subject of much recent research and development activity due to the environmental and long-term fuel supply concerns associated with fossil fuel burning engines and burners. Fuel cell technology generally promises a cleaner source of energy that is sufficiently compact and lightweight to enable use in vehicles. In addition, fuel cells may be located close to the point of energy use in stationary applications so as to greatly reduce the inefficiency associated with energy transmission over long distances.

Although many different reactants and materials may be used for fuel cells, all fuel cells generally have an anode and an opposing cathode separated by electrolyte. The anode and cathode generally have pores or channels so that reactant may be introduced into the cell through one of them, generally the anode, and oxidant introduced through the other, generally the cathode. The reactant oxidizes in the cell, producing direct current electricity with water and heat as by-products. Each cell generally produces an electrical potential of about one volt, but any number of cells may be connected in series and separated by separator plates in order to produce a fuel cell stack providing any desired value of electrical potential.

In modern fuel cell design, the anode, cathode, and electrolyte are often combined in a membrane electrode assembly, which may be a polymer electrolyte membrane with a gas diffusion layer, and the separator plates and current collectors are often combined in a “bipolar plate.” This bipolar plate bounds the flow channels for reactant, oxidant and coolant flow, and the starting materials for the energy conversion reaction. Details of fuel cell design and operation are further explained in “Fuel Cell Handbook, 5^{th} Edition”, published by the U.S. Department of Energy, National Energy Technology Laboratory, Morgantown, W. Va., October, 2000, attached hereto as Appendix A and hereby incorporated fully herein by reference. Various fuel cell components, including membrane electrode assemblies and bipolar plates, are further described in U.S. Pat. Nos. 4,988,583; 5,733,678; 5,798,188; 5,858,569; 6,071,635; 6,251,308; 6,436,568; and U.S. Published patent application Ser. No. 2002/0155333, each of which is hereby fully incorporated herein by reference.

A persistent challenge in the design of fuel cells is that of managing water and other liquids in the cell. Under some conditions, water is evolved very quickly by reaction within the cell. This water is generally produced on the cathode side of the cell, and if allowed to accumulate, may restrict or block the flow of fuel into the cell. Such a condition is known in the art as “cathode flooding.” In addition, the gases comprising the atmosphere in the cell often hold a significant amount of water vapor that is formed as a reaction byproduct or that is introduced intentionally to the cell for operational reasons. Temperature differences between the cell and ambient environment may be such that condensation of this water vapor occurs on the surfaces within cathode or anode flow channels, on balance of plant components, or on other surfaces in the cell as the water vapor laden gases move in and out of the cell during operation. Also, as in the case of direct methanol fuel cells for example, one or more of the reactant or oxidant materials may be in liquid form.

Materials of construction for the bipolar plate vary, but increasingly carbon particulate in a polymer binder is becoming the material of choice. Common structural polymers suitable for binders are typically lyophobic to some degree. Liquid that condenses on a lyophobic surface will tend to form droplets with a relatively high contact angle. As a result, when polymers are used in a bipolar plate, the water or other liquid tends to collect in a tight droplet on the bipolar plate inside the flow channel, leading to blockage or restriction of the flow channels as discussed above.

Generally, it is known that the lyophilicity of polymers for polar liquids such as water is improved by introducing polar groups on the surface of the polymer. As used herein, polar groups refer to chemical moieties having an affinity for water or another polar liquid, that may result from, for example, dipole or induced dipole interactions, acid-base interactions, hydrogen bonding, ionic interactions, or electrostatic interactions. These polar groups generally contain relatively electronegative elements, such as for example oxygen, nitrogen, chlorine, or sulfur, and may take the form of hydroxides, ethers, ester, carbonyls, carboxyls, amines, amides, halides, sulfonyls, or sulfonates.

Previous attempts have been made to develop polymeric fuel cell components having surfaces with improved wettability by introducing polar groups on the surface of the component. In one prior process, the surface of the component is oxidized by exposure to very high temperatures. The materials usable with such a high temperature process are necessarily limited, however, to those that are capable of resisting breakdown of the molecular structure and retaining structural integrity at very high temperatures. In addition, the need to heat and cool down the surfaces adds complexity, delay, and expense to the manufacturing process. As a result, use of such a process for high volume manufacturing of bipolar plates and other fuel cell components is problematic.

In another process, the surface of the component is treated with concentrated sulphuric acid. The chemical residue from this process is inimical to proper operation of a fuel cell. Complicated and expensive procedures are needed to remove the contaminants after treatment, again adding complexity, delay, and expense to the manufacturing process.

What is needed in the industry is an inexpensive, easily mass producible, polymeric fuel cell component having improved wettability.

### SUMMARY OF THE INVENTION

The present invention fulfills the need of the industry for an inexpensive, easily mass producible, polymeric fuel cell component having improved wettability. In an embodiment of the invention, a fuel cell component body is formed from polymer material. At least a portion of the surface of the component body is exposed to cold plasma to increase the lyophilicity of the exposed surface. The result is a fuel cell component with surfaces having improved lyophilicity so that liquid on the component adheres closely to the surface in relatively flat droplets or sheets. These surfaces may be selectively provided on critical areas of the component, such as for example on flow channel wall surfaces of bipolar plates and membrane electrode assemblies, thereby inhibiting liquid blocking of the flow channels during operation of the fuel cell.

In another embodiment of the invention, the component surfaces may be treated with ultraviolet light in the presence of ozone or oxygen to produce a surface with enhanced lyophilicity. In other embodiments of the invention, a thin layer of inherently hydrophilic polymer, such as polyvinyl alcohol, may be applied to the component surface to provide a lyophilic surface. The thin layer may be applied by plasma polymerization methods, film insert molding, compression molding or any other suitable method.

In any of the above methods, the lyophilic treatment may be targeted only on surfaces of the component where improved lyophilicity is desired. Alternatively, portions of the polymer treatment may be removed where lyophilic properties are not needed or desired.

### BRIEF DESCRIPTION OF THE DRAWINGS

FIG. 1 is a simplified cross-sectional view of a fuel cell stack apparatus with bipolar plates according to the present invention;

FIG. 2 is an enlarged partial view of the fuel cell stack apparatus of FIG. 1, depicting one flow channel in the apparatus;

FIG. 3 is a simplified schematic depiction of a cold plasma treatment apparatus;

FIG. 4 is a table of polymers suitable for bipolar plates and other fuel cell components;

FIG. 5 is a table of filler materials for modifying the conductivity of polymer fuel cell components;

FIG. 6 is a simplified schematic depiction of an ultraviolet light treatment apparatus;

FIG. 7 is a cross-sectional view of a fuel cell component depicting the component body with a lyophilic polymer layer thereon; and

FIG. 8 is a simplified schematic depiction of a plasma polymerization treatment apparatus.

### DETAILED DESCRIPTION OF THE INVENTION

For the purposes of this application, the term “fuel cell” means any electrochemical fuel cell device or apparatus of any type, including but not limited to proton exchange membrane fuel cells (PEMFC), alkaline fuel cells (AFC), phosphoric acid fuel cells (PAFC), molten carbonate fuel cells (MCFC), and solid oxide fuel cells (SOFC). The term “fuel cell stack apparatus” refers to an apparatus including at least one fuel cell and any and all components thereof, along with any and all of the separate components related to the functioning of the fuel cell, including but not limited to, enclosures, insulation, manifolds, piping, and electrical components.

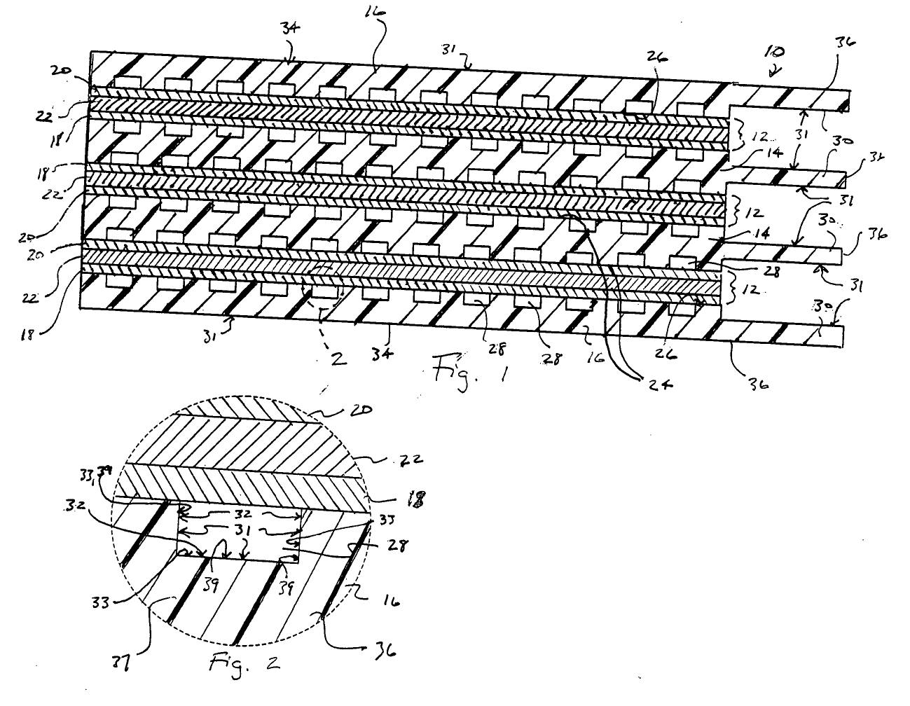

A portion of an embodiment of a fuel cell stack apparatus 10 according to the present invention is depicted in simplified cross section in FIG. 1. Fuel cell stack apparatus 10 generally includes membrane electrode assemblies 12, which are separated by bipolar plates 14. Single sided bipolar plates in the form of end plates 16 contain the apparatus 10 at each end. Each membrane electrode assembly 12 generally includes an anode membrane structure 18, a cathode membrane structure 20, and an electrolyte 22.

Plates 14, 16 generally include a plate body 23, 25, made from electrically conductive, corrosion and heat resistant material such as carbon filled polymer. Surfaces 24 of plates 14 and the inwardly facing surfaces 26 of plates 16 typically have flow channels 28 for conveying reactant and oxidant to membrane electrode assemblies 12, to drain away water. Heat transfer portions 30 of plates 14 and plates 16 may provide additional surface area to remove heat from the cells.

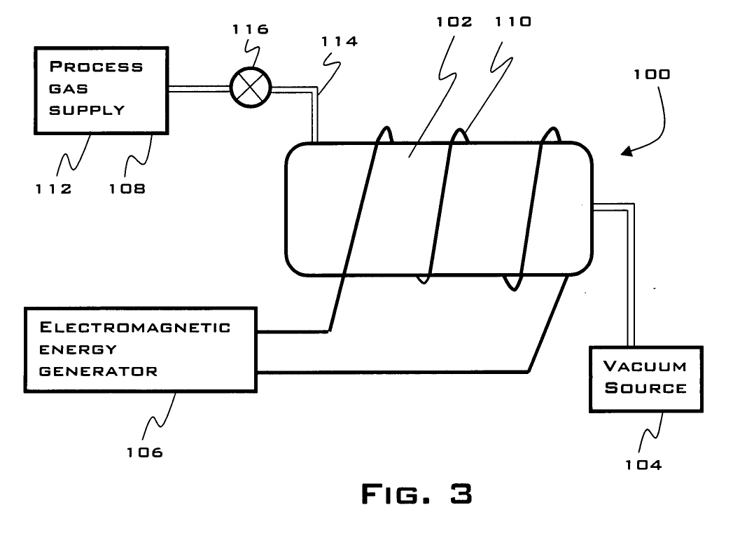

According to the invention, all or any desired portions of the outer surfaces of plates 14 or plates 16 may be lyophilic surfaces 31. As depicted in FIG. 2 for example, lyophilic surfaces 31 may be provided on the inwardly facing surfaces 32 of flow channels 28 to inhibit flooding in the channels 28. Water droplets evolved during the reaction process will adhere to flow channel walls 33 on lyophilic surfaces 31 in relatively flat droplets or sheets, thereby enabling flow channels 28 to remain open.

As depicted in FIG. 1, other portions of the bipolar plates 14 or end plates 16, such as heat transfer portions 30 and outer surfaces 34, may also be provided with lyophilic surfaces 31 to improve drainage of water collecting or condensing on these surfaces. Although not depicted herein, other components of the fuel cell stack assembly, such as gas diffusion layers, proton exchange membranes (PEMs), or balance of plant components may be provided with lyophilic surfaces 31 to improve fluid management within the cell.

In a first embodiment of the invention, a fuel cell component 36, which may be a bipolar plate 14, 16, has component body 37 with surface 39 that is treated with “cold” plasma. Plasma is an ionized gas composed of ions, electrons, radicals, atoms, and/or other neutral particles. Cold plasma, as the term is used herein, refers to plasma generated by glow discharge in a gaseous environment at reduced pressure, generally up to about 10 torr. The gaseous ions and molecules remain at ambient temperature, while the electrons reach electron temperatures of tens of thousands of degrees Kelvin. Electron temperature (Tₑ) of plasma may be determined according to the relation:

$${T}_{e} = ( \frac{e}{k} ) ( \frac{E {λ}_{e}}{2 \sqrt{2}} ) {( \frac{{m}_{m}}{{m}_{e}} )}^{1 / 2} {( \frac{π}{6} )}^{1 / 4}$$

where e is the electric charge, k is the Boltzmann constant, E is the electric field, λₑ is the mean free path of electrons, mₘ is the mass of neutral atoms and molecules in the plasma, and mₑ is the mass of electrons in the plasma. In cold plasma, although energetic, electrons embody only a tiny fraction of the thermal mass of the ions and neutral atoms within the plasma. As a result, the plasma remains relatively cool—generally around 300 degrees Kelvin (23 degrees C.).

Glow discharges may be generated between electrodes by applying a low frequency (e.g. 60 Hz) electrical potential of 500 to several thousand volts to the electrodes. Glow discharges may also be generated by introducing high frequency oscillations into the gas. These high frequency oscillations may be supplied by a spark gap generator (10 kHz to 50 kHz), a radio frequency (RF) generator (50 kHz to 150 MHz), or a microwave generator (150 MHz to 300 GHz). Further details of cold plasma treatments and their surface effects are generally discussed in a reference by Souheng Wu entitled “Polymer Interface and Adhesion”, Marcel Dekker, Inc., New York, N.Y., 1982, at pages 298-336, hereby fully incorporated herein by reference. Various processes for cold plasma treatment of polymeric materials to improve hydrophilicity of the material are described in U.S. Pat. Nos. 3,526,583; 3,870,610; 4,072,769; 4,188,426; and 5,314,539, each of which is fully incorporated herein by reference.

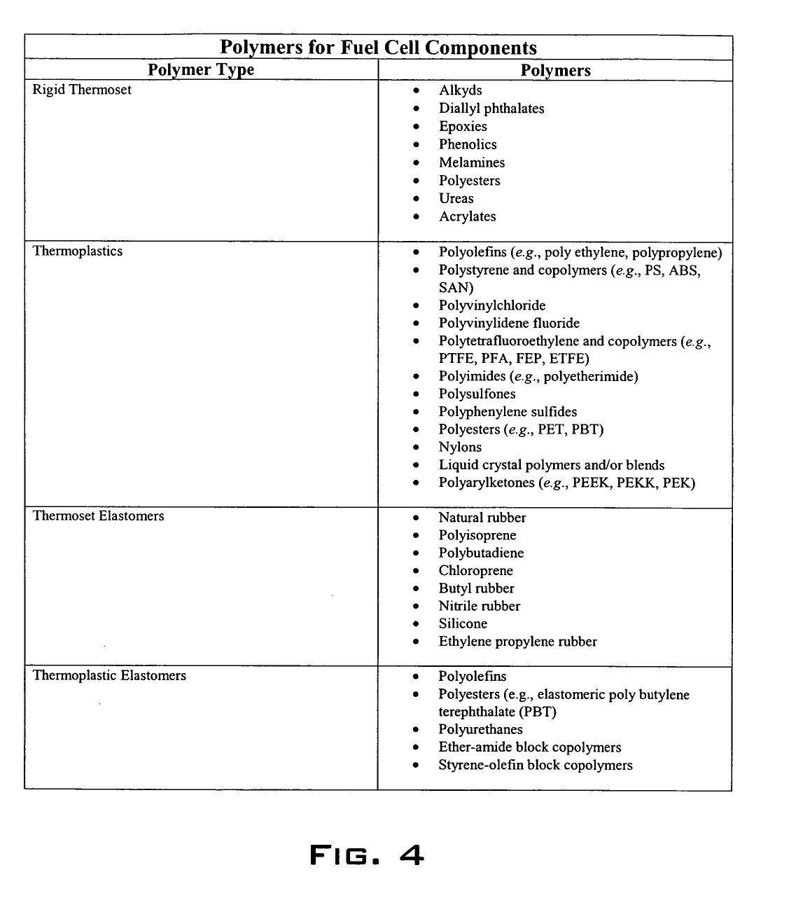

A simplified schematic depiction of one embodiment of a plasma treatment apparatus 100 is provided in FIG. 3. Plasma treatment apparatus 100 generally includes hermetic chamber 102, vacuum source 104, electromagnetic energy generator 106, and process gas supply system 108. Electromagnetic energy generator 106 which may be an RF or microwave generator as described herein above, is coupled with induction coil 110 that surrounds a portion of chamber 102. Vacuum source 104 may be any suitable vacuum source capable of producing a sufficient vacuum in chamber 102, generally 10 torr or less, and more preferably 1 torr or less. Process gas supply system 108 generally includes gas supply 112, which is connected with chamber 102 through tubing 114 and flow controller 116.

Generally according to an embodiment of the present invention, a fuel cell component 36 is placed in chamber 102 of plasma treatment apparatus 100. Vacuum source 104 is used to pump chamber 102 down to a predetermined vacuum pressure (base pressure). Once the base pressure is reached, process gas from gas supply 112 is introduced into chamber 102. Flow controller 116 is adjusted to stabilize the pressure in chamber 102 at a desired process pressure, which is generally less than about 10 torr. Cold plasma is then produced in chamber 102 by actuating electromagnetic energy generator 106. After a suitable length of time for accomplishing the treatment, the electromagnetic energy is shut off to extinguish the plasma. The chamber may then be restored to atmospheric pressure, and the treated fuel cell component 36 removed.

One commercially available plasma treatment apparatus found to be suitable for the present invention is the Plasmatech model V55, made by Plasmatech, Inc. of Erlanger, Ky. Any other suitable plasma treatment apparatus capable of producing and maintaining cold plasma in contact with a fuel cell component may also be used within the scope of the present invention.

In one specific embodiment of the present invention, bipolar plates 14, 16 are formed from thermoset vinyl ester (i.e. polyester) that has been combined with graphite, or other conductive carbon such as carbon black, for electrical conductivity. An electrically conductive graphite filled vinyl ester material for bipolar plates is commercially available under the designation “BMC-940” from Bulk Molding Compounds, Inc. of 1600 Powis Court, West Chicago, Ill. 60185. Bipolar plates 14, 16, may be formed by any suitable method, including the extrusion methods disclosed in co-pending U.S. patent application Ser. No. ______ filed on the same day as the present application, entitled “EXTRUDABLE BIPOLAR PLATES,” which is commonly owned by the owners of the present invention and fully incorporated herein by reference. Once formed, the bipolar plates 14, 16 are treated with the plasma treatment apparatus 100 as described above using pure oxygen as the process gas. The chamber 102 is pumped down to a base pressure of about 0.1 torr. The oxygen may be introduced to chamber 102 at a rate of about 300 ml/min. and the process pressure stabilized at about 1 torr. Electromagnetic energy may be applied in a sufficient amount to form cold plasma by glow discharge in chamber 102. After treatment for a suitable time period, generally from about 30 seconds up to 1 hour with 15 to 30 minutes being suitable for some embodiments, the electromagnetic energy is shut off and the chamber brought to atmospheric pressure.

Generally, the degree of wettability of the surface of bipolar plates 14, 16 increases with increased time of exposure to the cold plasma. After treatment for about 1 minute, the surface exhibits a contact angle for a sessile water droplet placed on the surface of about 25 to 40 degrees. After a 1 hour treatment, the surface may exhibit a contact angle for a water droplet of nearly zero.

It will be appreciated that other values of process gas pressure and flow may be used to vary the processing results. Moreover, although oxygen is the process gas currently most preferred, it is anticipated that other suitable gases and vapors may be used with the process. The different process gases may be selected to provide corresponding surface modifications. Other such suitable gases and vapors may include for example: air; nitrogen; argon; alkylamines; alkylsilanes; ammonia; carbon dioxide; chlorine; chlorine dioxide; chlorofluorocarbons such as chlorotrifluoromethane; chlorohydrocarbons such as chloroform, methyl chloride, and ethyl chloride; nitrous oxide; ozone; water vapor; alkyoxysilanes; allyl alcohol; carbon tetrachloride; ethylene glycol; monomethyl ether; ethylene oxide; carbon monoxide; nitroalkanes; nitrogen; nitrogen dioxide; and sulfur oxides.

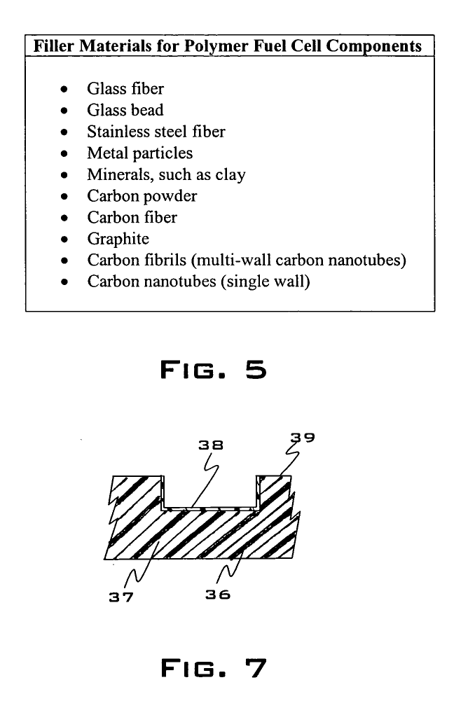

Although thermoset vinyl ester material was used in the above example, it is anticipated that the process of the present invention may be used to treat polymer bipolar plates 14, 16 and other fuel cell components of essentially any composition capable of the formation of polar groups at the surface of the material. A partial list of other polymer materials suitable for forming bipolar plates and other fuel cell components is provided in FIG. 4. The conductivity of these materials may be modified with the inclusion of filler materials, a partial list of which is provided in the table of FIG. 5.

It will be appreciated that cold plasma treatment may be selectively targeted to only portions of the outer surface of component 36 where a lyophilic surface is desired. In one embodiment, a removable mask may be applied over portions of the surface of component 36 not to be plasma treated. After treatment, the mask may be removed to expose the untreated portions. In other embodiments, the entire surface of component 36 may be treated, and the treated surface physically removed at portions where the treated surface is not desired. Generally, the treated surface is a thin layer ranging from about 10 nm to 100 nm in thickness. Consequently, it is anticipated that any physical removal means capable of removing a polymer layer of such a thickness without unduly damaging the underlying substrate is suitable for use in the present invention, including precision grinding and milling apparatus, such as for example a CNC mill.

In other embodiments of the invention, selected portions of component 36 may be plasma treated with atmospheric pressure cold plasma treatment apparatus. One atmospheric cold plasma treatment apparatus that may be suitable for use in the present invention is described in U.S. Pat. No. 6,502,558, hereby fully incorporated herein by reference. Another plasma treatment apparatus that may enable selected portions of component 36 to be plasma treated at atmospheric pressure is described in U.S. Pat. No. 5,693,241, also hereby fully incorporated herein by reference.

Because the treatment processes described above are cold processes, they offer significant advantages over previously employed processes. Treatment heating and cool down time may be virtually eliminated, resulting in accelerated and more efficient manufacturing processes. In addition, due to their low temperature, these processes do not cause significant dimensional distortion of the component. Also, the absence of chemical agents in the treatment processes significantly reduces the amount of post treatment cleaning needed for the bipolar fuel components, further enhancing efficiency and lowering cost. Further, the cold plasma treatment processes described above generally increase the conductivity of polymer fuel cell components 34 having conductive filler, which is beneficial for certain fuel cell components such as bipolar plates.

An improvement in the lyophilicity of the surface of a polymer fuel cell component may also be achieved by treatment of the surface with ultraviolet (UV) light. In some embodiments, the component is exposed to oxygen, and irradiated with high-energy UV radiation including UV radiation a wavelength of about 184.7 nm. The UV radiation interacts with the oxygen, creating ozone and oxygen radicals, which oxidize the surface of the polymer component. In other embodiments, the component is exposed to ozone, and irradiated with UV radiation including UV radiation at a wavelength of about 254 nm. The UV radiation dissociates the ozone into molecular and atomic oxygen, thereby creating an aggressive oxidizing environment that oxidizes the surface of the polymer component. Moreover, direct UV irradiation of the polymer surface of the component in each of these embodiments may break bonds in the polymer, so that when the surface is exposed to the oxidizing environment, highly polar hydroxyl, carbonyl, or carboxylic groups are formed, thereby improving the lyophilicity of the surface. High energy UV radiation at wavelengths in a range from about 140 nm to about 400 nm, or more preferably in a range from about 184 nm to about 365 nm may be most effective.

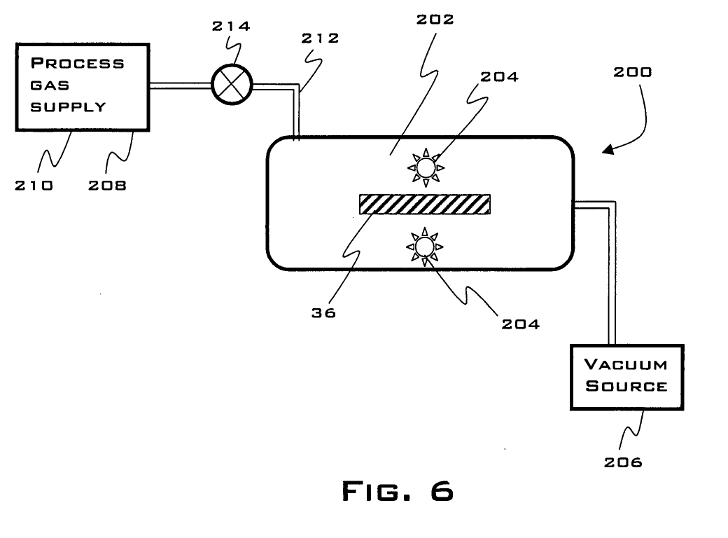

An ultraviolet treatment apparatus 200 that may be suitable for practicing the present invention is depicted in simplified schematic form in FIG. 6. Ultraviolet treatment apparatus 200 generally includes hermetic chamber 202, UV light source 204, vacuum source 206, and process gas supply system 208. Chamber 202 is preferably made from UV resistant material.

UV light source 204 may be a xenon, mercury vapor, or other lamp capable of emitting UV radiation of the desired wavelength. Lamps that produce high energy UV at 254 nm and 184.7 nm are preferred for UV light source 204. Specific lamps that may be suitable for use as UV light source 204 include the RC-500, RC-600, RC-742, RC-747, and RC-1002 model xenon lamp systems, fitted with type C, D, or E lamps, commercially available from Xenon Corporation, 20 Commerce Way, Woburn, Mass., 01801. UV light source 204 and component 36 are preferably positioned in chamber 202 so that from 150 mJ/cm² to 300 mJ/cm² of UV radiation is produced at the surface of component 36 when UV light source 204 is activated. It will be appreciated that multiple UV light sources 204 may be positioned around chamber 202 to enable simultaneous UV irradiation of multiple surface portions of component 36.

Vacuum source 206 may be any suitable vacuum source capable of producing a sufficient vacuum in hermetic chamber 202, generally 10 torr or less, and more preferably 1 torr or less. Process gas supply system 208 generally includes gas supply 210 connected with chamber 202 through tubing 212 and flow controller 214. The process gas supplied by process gas supply system 208 may be ozone, molecular or atomic oxygen, or other suitable oxidizer, such as sulphur dioxide, nitrous oxide, or nitrogen dioxide.

In one specific embodiment of the invention, a fuel cell component 36 is placed in hermetic chamber 202. Vacuum source 206 is actuated until chamber 202 is evacuated to a suitable base pressure, generally between about 0.0001 to 20 torr and more preferably between about 0.5 and 1 torr. In the next step, ozone is introduced into chamber 202 through process gas supply system 208 and the gas pressure in chamber 202 is stabilized at a process pressure, which may be at or near the base pressure. UV light source 204 is then switched on to irradiate the ozone and component 36. It is anticipated that maintaining the treatment for a period of between 30 seconds to one hour may be effective to yield improvement in the wettability of the surface of component 36. As an alternative to ozone as the process gas, molecular or atomic oxygen may be used as the process gas, and ozone created in situ by UV radiation having a wavelength of 184.7 nm.

Further details of a UV treatment processes that may be suitable for use in the present invention are specified in a publication by Bhurke, et. al. entitled “Ultraviolet Light Surface Treatment of Polymers and Composites to Improve Adhesion”, included in the Proceedings of the 26^{th} Annual Meeting of the Adhesion Society, Inc., held Feb. 23-26, 2003, published in 2003 by the Adhesion Society, Inc. and identified as ISSN 1086-9506, hereby fully incorporated herein by reference. Further general information about UV/Ozone treatment processes may be found in a publication by John R. Vig entitled “UV/Ozone Cleaning of Surfaces”, J. Vac. Sci. Technol., May/June 1985, at pages 1027-1034, also fully incorporated herein by reference.

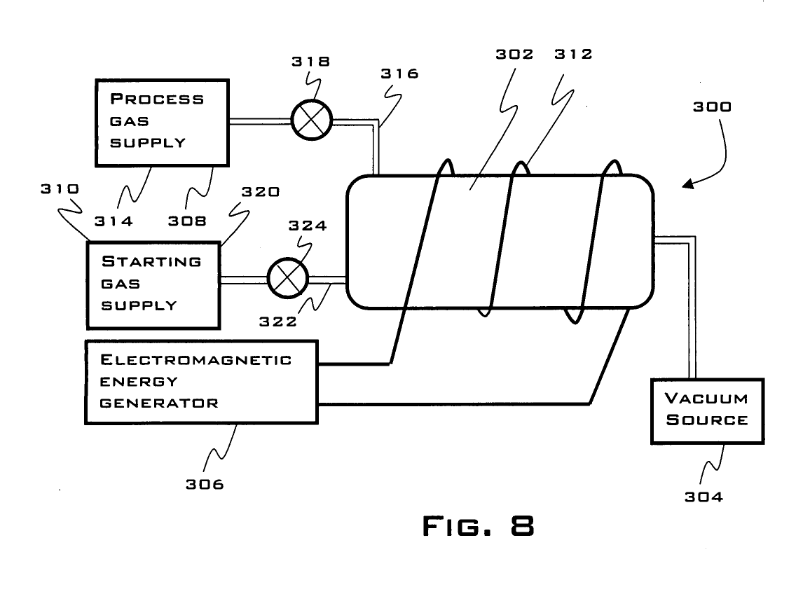

As depicted in FIG. 7, it is also anticipated that surface wettability of a fuel cell component 36 may be enhanced by applying a thin layer 38 of an inherently lyophilic polymer, such as polyvinyl alcohol (PVOH), to the surface. Other lyophilic polymers that may be suitable for layer 38 include: polyalkylene glycols such as polyethylene glycol and polypropylene glycol; cellulose and functionalized cellulose compounds such as hydroxyethyl cellulose; polyacrylonitriles; polyacrylamides; polyvinylamides; polyvinylsaccharides; polyaminoacrylates; poly hydroxyalkyl acrylates such as 2-hydroxethyl methacrylate; polyacrylic acids; polyacrylic acid salts; and functionalized styrene ionomers such as poly(sodium styrene sulfonate). One method of assessing the suitability of a polymer for use in layer 38 is by observing the wetting characteristics of a planar sample of the bulk polymer after immersion in water. Generally, sheeting of water over the surface and a lack of beading after immersion are positive indications of a suitable polymer material. In the alternative, the advancing contact angle of a liquid droplet on a horizontal planar surface of a sample of the bulk polymer may be observed. An advancing contact angle of 45 degrees or less is generally a positive indication of a suitable polymer material for layer 38.

In one embodiment, PVOH in powder form may be mixed with water and a suitable cross-linking agent and applied to the surface of the component 36. For example, a liquid PVOH solution may be made from 0.5% Celvol™ 325 polyvinyl alcohol and 20% glyoxal dehydrate cross-linking agent (125 μl in 10 ml of Celvol™ 325). Celvol™ 325 is commercially available from Celanese Chemicals of Calvert City, Ky. A thin coating of the PVOH solution is applied to the surface of the component 36 by any suitable means and allowed to dry, thereby forming layer 38 on component 36. It is generally preferred that the thickness of layer 38 be in a range from about 100 nm to about 1 mm, and more preferably in a range from about 1 μm to about 100 μm. Adhesion of the layer 38 to component 36 may be enhanced by treating the surface of component 36 with cold plasma as outlined above prior to application of layer 38.

It will be appreciated that layer 38 may be selectively applied only to portions of component 36 where lyophilic properties are desired (e.g. interior surfaces of flow channels of bipolar plates). Selective application of layer 38 may be accomplished by applying a removable mask (not depicted) over the surface regions of component 36 where layer 38 is to be omitted. After layer 38 has been applied over the mask and the unmasked portions of component 36, the mask may be removed. In other embodiments, layer 38 may be selectively applied only to desired portions of component 36 using an automatic dispenser. One such automatic dispenser system that may be suitable for use in the present invention is the model DK118 digital dispenser commercially available from I & J Fisnar, 2-07 Banta Place, Fairlawn, N.J. If desired, the automatic dispenser may be robotically automatically positioned. A robotic positioning apparatus that may be suitable for use in positioning an automatic dispenser is the model I&J 7400 robot, also commercially available from I & J Fisnar.

In another embodiment of the invention, the lyophilic polymer may be provided in the form of thin sheet stock (e.g. ≦1 mm) and bonded to the surface of component 36 using the film insert molding methods disclosed in PCT Patent Application No. PCT/US02/37966 entitled PERFORMANCE POLYMER FILM INSERT MOLDING FOR FLUID CONTROL DEVICES and PCT Patent Application No. PCT/US02/38076 entitled SEMICONDUCTOR COMPONENT HANDLING DEVICE HAVING AN ELECTROSTATIC DISSIPATING FILM, which are commonly owned by the owner of the present invention, each of which is hereby fully incorporated herein by reference. It will be appreciated that using these methods, the thin film layer 38 may be selectively targeted to only portions of the surface of component 36 where lyophilic properties are desired (e.g. inside flow channels of bipolar plates), thereby obviating any need for removal of layer 38 on portions of component 36 where lyophilic properties are not desired.

In other embodiments, layer 38 may be applied by compression molding lyophilic polymer in the form of thin cross-linked sheet stock to the surface of component 36 using known compression molding techniques. In other embodiments, layer 38 may be applied by melting the lyophilic polymer over a surface of component 36.

Layer 38 may also be applied by known plasma polymerization techniques. Generally, in plasma polymerization, a layer of polymer is deposited on a substrate by introducing an organic compound (e.g. a monomer) into plasma in a reactor. The monomer gains energy from the plasma through inelastic collision and is activated and thereby reacts with other monomers or oligomers. These smaller molecules combine and deposit on the substrate and reactor surfaces as a polymer. Plasma polymerization processes that may be suitable for deposition of layer 38 on a component 36 in the context of the present invention are described in U.S. Pat. Nos. 3,518,108; 3,666,533; 4,013,532; 4,188,273; and 5,447,799, each of which is fully incorporated herein by reference.

A simplified schematic depiction of one embodiment of a plasma polymerization apparatus 300 is provided in FIG. 8. Plasma polymerization apparatus 300 generally includes hermetic chamber 302, vacuum source 304, electromagnetic energy generator 306, process gas supply system 308, and starting gas supply 310. Electromagnetic energy generator 306 which may be an RF or microwave generator as described herein above for plasma treatment apparatus 100, is coupled with induction coil 312 that surrounds a portion of chamber 302. Vacuum source 304 may be any suitable vacuum source capable of producing a sufficient vacuum in chamber 302, generally 10 torr or less, and more preferably 1 torr or less. Process gas supply system 308 generally includes gas supply 314 connected with chamber 302 through tubing 316 and flow controller 318. Starting gas supply 310 generally includes gas supply 320 connected with chamber 302 through tubing 322 and flow controller 324. Another apparatus that may be suitable for use in the present invention is disclosed in U.S. Pat. No. 6,156,435, hereby fully incorporated herein by reference.

Generally according to an embodiment of the present invention, a fuel cell component 36 is placed in chamber 302 of plasma treatment apparatus 300. Vacuum source 304 is used to pump chamber 302 is down to predetermined vacuum pressure (base pressure). Once the base pressure is reached, process gas from gas supply 314 is introduced into chamber 302. Flow controller 318 is adjusted to stabilize the pressure in chamber 302 at a desired process pressure, which is generally less than about 10 torr. Cold plasma is then produced in chamber 302 by actuating electromagnetic energy generator 306. Starting gas from starting gas supply 310 is then introduced into chamber 302 to begin deposition of layer 38. Once layer 38 has reached a suitable thickness, the electromagnetic energy is shut off to extinguish the plasma and the flow of starting gas from starting gas supply 310 is ceased. Chamber 302 may then be restored to atmospheric pressure, and the fuel cell component 36 with deposited layer 38 removed.

The starting gas supplied by starting gas supply may be any organic or inorganic monomer or other compound in gaseous or vapor form capable of forming a lyophilic polymer. Examples of starting gases suitable for starting gas supply 310 include ethylene oxide, nitroethane, 1-nitropropane (C₃H₇NO₂), 2-nitropropane ((CH₃)₂CHNO₂), ethylene, methane and trimethylamine. Moreover, a hydrophilic silicon oxide layer 38 may be formed on component 36 using silane or chlorosilane as the starting gas. Examples of silane compounds that may be suitable for use in the present invention include: amino silanes (e.g. amino propyl trimethoxy silane, N-(2-amino ethyl)-3-amino propyl triethoxy silane, or Bis[(3-trimethoxysilyl)]ethylenediamine); poly alkylene oxide silanes (e.g. 2-[methoxy(polyethyleneoxy)propyl]trimethoxy silane); urethane silanes (e.g. N-(triethoxy silyl propyl)-o-polyethylene oxide urethane); and hydroxyl silanes (e.g. hydroxyl methyl triethoxy silane).

For some components 34, such as bipolar plates 14, 16, it may be desirable that layer 38 be relatively electrically conductive. An electrically conductive layer 38 may be produced by introducing a conductive particulate such as carbon into chamber 302 during the plasma polymerization process. An apparatus and method that may be suitable for producing a conductive polymer film on a fuel cell component by plasma polymerization is disclosed in U.S. Pat. No. 4,422,915, hereby fully incorporated herein by reference.

Once again, it may be desirable in some embodiments to selectively target the plasma polymerized layer 38 to only those portions of component 36 where enhanced lyophilicity is desired. As described above, selective application of layer 38 may be accomplished by applying a removable mask (not depicted) over the surface regions of component 36 where layer 38 is to be omitted. After layer 38 has been applied over the mask and the unmasked portions of component 36, the mask may be removed to expose the untreated portions. Also, layer 38 may be physically removed in regions where enhanced lyophilicity is not desired by common machining methods such as grinding or milling.

The present invention may be embodied in other specific forms without departing from the central attributes thereof, therefore, the illustrated embodiments should be considered in all respects as illustrative and not restrictive. It is contemplated that features disclosed in this application, as well as those described in any references incorporated herein by reference, can be combined or modified to suit particular circumstances. Various other modifications and changes will be apparent to those of ordinary skill.

What is claimed is:

1. A polymeric bipolar plate for a fuel cell, the bipolar plate made by a process comprising the steps of:
forming a plate body from polymer material, the plate body having an outer surface; and
exposing at least a portion of the outer surface of the plate body to cold plasma to increase the lyophilicity of the outer surface portion.

2. The bipolar plate of claim 1, wherein the plate body is made from at least one polymer material selected from the group consisting of alkyds, diallyl phthalates, epoxies, phenolics, melamines, polyesters, ureas, acrylates, polyolefins, polystyrene, polystyrene copolymers, polyvinylchloride, polyvinylidene fluoride, polytetrafluoroethylene, polytetrafluoroethylene copolymers, polyimides, polysulfones, polyphenylene sulfides, polyesters, nylons, liquid crystal polymers and blends, polyarylketones, natural rubber, polyisoprene, polybutadiene, chloroprene, butyl rubber, nitrile rubber, silicone, ethylene propylene rubber, polyolefins, polyesters, polyurethanes, ether-amide block copolymers, and styrene-olefin block copolymers.

3. The bipolar plate of claim 2, wherein the plate body is made from thermoset vinyl ester.

4. The bipolar plate of claim 2, wherein the plate body contains a filler material selected from the group consisting of glass fiber, glass bead, stainless steel fiber, metal particles, minerals, carbon powder, carbon fiber, graphite, carbon fibrils, and carbon nanotubes.

5. The bipolar plate of claim 1, wherein the process further comprises the steps of enclosing the plate body in a hermetic chamber, evacuating the hermetic chamber to a base pressure less than atmospheric pressure, introducing a process gas to the hermetic chamber, and applying a sufficient amount of electromagnetic energy to the process gas to produce the cold plasma.

6. The bipolar plate of claim 5, wherein the process further comprises the step of selecting the process gas from the group consisting of air, nitrogen, argon, alkylamines, alkylsilanes, ammonia, carbon dioxide, chlorine, chlorine dioxide, chlorofluorocarbons, chlorohydrocarbons, nitrous oxide, ozone, water vapor, alkyoxysilanes, allyl alcohol, carbon tetrachloride, ethylene glycol, monomethyl ether, ethylene oxide, carbon monoxide, nitroalkanes, nitrogen, nitrogen dioxide, and sulfur oxides.

7. The bipolar plate of claim 6, wherein the process gas is oxygen.

8. The bipolar plate of claim 1, wherein the process further comprises the step of maintaining the cold plasma in contact with the outer surface for at least 30 seconds.

9. The bipolar plate of claim 1, wherein the process further comprises the step of maintaining the cold plasma in contact with the outer surface for between about fifteen minutes and about thirty minutes.

10. The bipolar plate of claim 1, wherein the entire outer surface of the plate body is exposed to the cold plasma.

11. The bipolar plate of claim 1, wherein the process further comprises the step of physically removing at least a portion of the outer surface of the plate body.

12. A fuel cell including at least one polymeric bipolar plate, the bipolar plate made by a process comprising the steps of:
forming a plate body from polymer material, the plate body having an outer surface; and
exposing at least a portion of the outer surface of the plate body to cold plasma to increase the lyophilicity of the outer surface portion.

13. The fuel cell of claim 12, wherein the plate body of the bipolar plate is made from thermoset vinyl ester.

14. The fuel cell of claim 12, wherein the plate body of the bipolar plate contains a filler material selected from the group consisting of glass fiber, glass bead, stainless steel fiber, metal particles, minerals, carbon powder, carbon fiber, graphite, carbon fibrils, and carbon nanotubes.

15. The fuel cell of claim 12, wherein the process further comprises the steps of enclosing the plate body in a hermetic chamber, evacuating the hermetic chamber to a base pressure less than atmospheric pressure, introducing a process gas to the hermetic chamber, and applying a sufficient amount of electromagnetic energy to the process gas to produce the cold plasma.

16. The fuel cell of claim 15, wherein the process further comprises the step of selecting the process gas from the group consisting of air, nitrogen, argon, alkylamines, alkylsilanes, ammonia, carbon dioxide, chlorine, chlorine dioxide, chlorofluorocarbons, chlorohydrocarbons, nitrous oxide, ozone, water vapor, alkyoxysilanes, allyl alcohol, carbon tetrachloride, ethylene glycol, monomethyl ether, ethylene oxide, carbon monoxide, nitroalkanes, nitrogen, nitrogen dioxide, and sulfur oxides.

17. The fuel cell of claim 15, wherein the process gas is oxygen.

18. The fuel cell of claim 12, wherein the process further comprises the step of maintaining the cold plasma in contact with the outer surface for at least 30 seconds.

19. The fuel cell of claim 12, wherein the process further comprises the step of maintaining the cold plasma in contact with the outer surface for between about fifteen minutes and about thirty minutes.

20. The fuel cell of claim 12, wherein the entire outer surface of the plate body is exposed to the cold plasma.

21. The fuel cell of claim 12, wherein the process further comprises the step of physically removing at least a portion of the outer surface of the plate body.

22. A polymeric fuel cell component having a lyophilic surface portion, the component made by a process comprising the steps of:
forming the component from polymer material, the component having an outer surface; and
exposing at least a portion of the outer surface of the component to cold plasma to increase the lyophilicity of the outer surface portion.

23. The fuel cell component of claim 22, wherein the component is a bipolar plate.

24. The fuel cell component of claim 22, wherein the component is made from at least one polymer material selected from the group consisting of alkyds, diallyl phthalates, epoxies, phenolics, melamines, polyesters, ureas, acrylates, polyolefins, polystyrene, polystyrene copolymers, polyvinylchloride, polyvinylidene fluoride, polytetrafluoroethylene, polytetrafluoroethylene copolymers, polyimides, polysulfones, polyphenylene sulfides, polyesters, nylons, liquid crystal polymers and blends, polyarylketones, natural rubber, polyisoprene, polybutadiene, chloroprene, butyl rubber, nitrile rubber, silicone, ethylene propylene rubber, polyolefins, polyesters, polyurethanes, ether-amide block copolymers, and styrene-olefin block copolymers.

25. The fuel cell component of claim 22, wherein the component is made from thermoset vinyl ester.

26. The fuel cell component of claim 22, wherein the component contains a filler material selected from the group consisting of glass fiber, glass bead, stainless steel fiber, metal particles, minerals, carbon powder, carbon fiber, graphite, carbon fibrils, and carbon nanotubes.

27. The fuel cell component of claim 22, wherein the process further comprises the steps of enclosing the component in a hermetic chamber, evacuating the hermetic chamber to a base pressure less than atmospheric pressure, introducing a process gas to the hermetic chamber, and applying a sufficient amount of electromagnetic energy to the process gas to produce the cold plasma.

28. The fuel cell component of claim 27, wherein the process further comprises the step of selecting the process gas from the group consisting of air, nitrogen, argon, alkylamines, alkylsilanes, ammonia, carbon dioxide, chlorine, chlorine dioxide, chlorofluorocarbons, chlorohydrocarbons, nitrous oxide, ozone, water vapor, alkyoxysilanes, allyl alcohol, carbon tetrachloride, ethylene glycol, monomethyl ether, ethylene oxide, carbon monoxide, nitroalkanes, nitrogen, nitrogen dioxide, and sulfur oxides.

29. The fuel cell component of claim 27, wherein the process gas is oxygen.

30. The fuel cell component of claim 22, wherein the process further comprises the step of maintaining the cold plasma in contact with the outer surface for at least 30 seconds.

31. The fuel cell component of claim 22, wherein the process further comprises the step of maintaining the cold plasma in contact with the outer surface for between about fifteen minutes and about thirty minutes.

32. The fuel cell component of claim 22, wherein the entire outer surface of the plate body is exposed to the cold plasma.

33. The fuel cell component of claim 22, wherein the process further comprises the step of physically removing at least a portion of the outer surface of the component.

34. A method of inhibiting cathode flooding in a fuel cell comprising steps of:
providing a fuel cell including a plurality of bipolar plates and a plurality of membrane electrode assemblies defining a plurality of flow channels, each flow channel bounded by a flow channel wall;
forming a lyophilic surface on a portion of the flow channel wall of each flow channel so that water condensing in the flow channel during operation of the fuel cell adheres to the flow channel wall and does not block the flow channel.

35. The method of claim 34, wherein the lyophilic surface is formed by a process comprising exposing a portion of the flow channel wall surface to cold plasma.

36. The method of claim 34, wherein the lyophilic surface is formed by a process comprising the steps of exposing a portion of the flow channel wall to ozone at a pressure less than ambient atmospheric pressure; and
irradating the flow channel wall surface portion and the ozone with ultraviolet light energy.

37. The method of claim 36, wherein the ultraviolet light energy has a wavelength between about 140 nm and about 400 nm.

38. The method of claim 36, wherein the ultraviolet light energy has a wavelength between about 184 nm and about 365 nm.

39. The method of claim 36, wherein the ultraviolet light energy has a wavelength of about 184.7 nm.

40. The method of claim 36, wherein the ultraviolet light energy has a wavelength of about 254 nm.

41. The method of claim 36, further comprising the steps of exposing the flow channel wall portion to oxygen and forming the ozone in situ by irradiating the oxygen with ultraviolet light energy.

42. A polymeric fuel cell component having a lyophilic surface portion, the component made by a process comprising the steps of:
forming the component from polymer material, the component having an outer, surface; and
irradiating at least a portion of the outer surface of the component with ultraviolet light energy to increase the lyophilicity of the outer surface portion.

43. The fuel cell component of claim 42, wherein the component is made from at least one polymer material selected from the group consisting of alkyds, diallyl phthalates, epoxies, phenolics, melamines, polyesters, ureas, acrylates, polyolefins, polystyrene, polystyrene copolymers, polyvinylchloride, polyvinylidene fluoride, polytetrafluoroethylene, polytetrafluoroethylene copolymers, polyimides, polysulfones, polyphenylene sulfides, polyesters, nylons, liquid crystal polymers and blends, polyarylketones, natural rubber, polyisoprene, polybutadiene, chloroprene, butyl rubber, nitrile rubber, silicone, ethylene propylene rubber, polyolefins, polyesters, polyurethanes, ether-amide block copolymers, and styrene-olefin block copolymers.

44. The fuel cell component of claim 43, wherein the component contains a filler material selected from the group consisting of glass fiber, glass bead, stainless steel fiber, metal particles, minerals, carbon powder, carbon fiber, graphite, carbon fibrils, and carbon nanotubes.

45. The fuel cell component of claim 42, wherein the process further comprises the steps of enclosing the component in a hermetic chamber, evacuating the hermetic chamber to a base pressure less than atmospheric pressure, and introducing a process gas to the hermetic chamber.

46. The fuel cell component of claim 45, wherein the process gas is ozone.

47. The fuel cell component of claim 45, wherein the process gas is oxygen.

48. The fuel cell component of claim 42, wherein the ultraviolet light energy has a wavelength between about 140 nm and about 400 nm.

49. The fuel cell component of claim 42, wherein the ultraviolet light energy has a wavelength between about 184 nm and about 365 nm.

50. The fuel cell component of claim 42, wherein the ultraviolet light energy has a wavelength of about 184.7 nm.

51. The fuel cell component of claim 42, wherein the ultraviolet light energy has a wavelength of about 254 nm.

52. The fuel cell component of claim 42, wherein the process further comprises the step of physically removing at least a portion of the outer surface of the component.
